(19) United States
(12) Patent Application Publication
(10) Pub. No.: US 2023/0132328 A1
(43) Pub. Date: Apr. 27, 2023

(54) Luminaire Head with Improved Heatsink

(71) Applicant: Schreder S.A., Brussels (BE)

(72) Inventors: Csaba HORVATH, Budapest (HU); János Péter SZÜGYI, Mako (HU); Janki ZOLTÁN, Gyömró (HU)

(21) Appl. No.: 17/905,872

(22) PCT Filed: Mar. 9, 2021
(86) PCT No.: PCT/EP2021/055893

§ 371 Date: Sep. 8, 2022

(30) Foreign Application Priority Data
Mar. 9, 2020 (NL) 2025081

(51) Int. Cl. F21V 29/81; F21S 8/08

(52) U.S. Cl. CPC F21V 29/81; F21S 8/086

(57) ABSTRACT

Example embodiments relate to luminaire heads with improved heatsinks. One embodiment includes an assembly, such as a luminaire head. The assembly includes a housing and an electrical component, such as a light source, arranged in the housing. The housing has a first side and an optional second side opposite the first side. At least the first side is provided with a heatsink portion having an outer surface provided with multiple heatsink elements protruding outwardly out of the outer surface. A heatsink element thereof has a base and a top. The heatsink element gradually widens from the top to the base.

### FIELD OF INVENTION

The present invention relates to an assembly, in particular an assembly intended to be attached to or included in a pole, such as luminaire head, with a heatsink. Particular embodiments relate to a luminaire head for outdoor applications, and in particular a luminaire head intended for being connected to a lamp post.

### BACKGROUND

It is well known that luminaire heads heat up during operation due notably to the heat produced by the light source in the luminaire head. To evacuate the generated heat a luminaire is typically provided with a heatsink.

An example of a luminaire head with heatsink is disclosed in WO2019197489A1 in the name of the applicant. The luminaire head of WO2019197489A1 has a metal body which functions as heatsink, as pole fixation, and as mounting means for the light emitting elements. The heatsink comprises cooling fins integrated in the metal body. While cooling fins work well for evacuating heat, for some applications they have the disadvantage that dirt and other material may be collected between the fins.

### SUMMARY

The object of embodiments of the invention is to provide an assembly, such as a luminaire head, providing a good evacuation of the heat whilst limiting the amount of debris on the assembly, and in particular having a housing portion with a heatsink, which can be easily moulded.

According to a first aspect, there is provided an assembly, such as a luminaire head comprising a housing and an electrical component, such as a light source arranged in the housing. The housing has a first side and an optional second side opposite the first side. The second side is intended to be oriented towards the area to be illuminated, e.g. the ground. When the assembly is a luminaire head, the second side may be provided with a transparent or translucent portion opposite the light source, such that light rays emitted by the light source can leave the housing through the transparent or translucent portion. The first side is provided with a heatsink portion, e.g. opposite the light source when the assembly is a luminaire head. The heatsink portion has an outer surface provided with multiple heatsink elements protruding outwardly out of said outer surface, wherein a heatsink element thereof has a base and a top and wherein the heatsink element gradually widens from the top to the base.

By providing multiple heatsink elements which have a shape narrowing from base till top, water and dirt can be more easily evacuated as the hill-like shape will create fluid flows around the multiple heatsink elements. Further, such a shape of the multiple heatsink elements allows for a convenient demoulding of the heatsink portion out of a mould, and allows the heatsink elements to be an integral part of the housing.

Preferably, seen in a mounted position, the first side is an upper side and the outer surface is an upper outer surface. Especially for such surfaces the shape of the multiple heatsink elements allows for a good evacuation of heat in combination with a good evacuation of dirt and water. However, the first surface may also be a peripheral surface, e.g. a vertical or inclined or curved surface.

Embodiments of the invention may be useful for any kind of electrical components which need to be included in a closed housing and which generate heat. For example, the electrical component may be a processing means, a communication means, a sensor or a portion thereof, a power supply, a driver configured for driving a load such as a light source, etc.

Preferably, seen in a cross section, a base surface area of the heatsink element at the base is at least 10% larger than a middle surface area of the heatsink element halfway between the top and the base. More preferably, the peripheral wall of the heatsink element is curved between the base surface area and the middle surface area, and runs gradually inwardly from the base to an edge of the middle surface area. Preferably, the curvature is present when looking in a section perpendicular on the outer surface of the first side. Such a shape will help the demoulding as the curved narrowing peripheral wall does not have sharp angles and can easily be removed from the mould. At the same time a fluid flow can run smoothly over the peripheral wall. Further, by having a curved peripheral wall, the surface area of the peripheral wall is increased compared to a vertical peripheral wall having the same height resulting in a good evacuation of heat. Further, also a circumference of the heatsink element at the base and/or halfway the base and the top may have a curved shape. This may further improve a self cleaning effect and/or evacuation of water/dirt.

Preferably, seen in a cross section parallel to the base, the heatsink element has an elongate shape, wherein preferably, at the level of the base, a maximal length is at least 1.3 times a maximal width, preferably at least 1.5 times the maximal width. By using an elongate shape as opposed to a round shape, the surface area of the heatsink element is further increased, resulting in an improved evacuation of heat. Preferably, the maximal length (11) is less than 7 times the maximal width preferably less than 5 times, more preferably less than 4 times.

Preferably, for at least for some of the multiple heatsink elements, the maximal length is between and 100 mm, more preferably between 5 mm and 60 mm, e.g. between 15 mm and 50 mm. Such lengths allow on the one hand a good evacuation of heat and on the other hand a good flow of fluid (e.g. water and/or dirt) in between the heatsink elements.

Preferably, a distance between two adjacent heatsink elements of said multiple heatsink elements is more than 8 mm, preferably more than 10 mm. Preferably, a distance between two adjacent heatsink elements of said multiple heatsink elements is larger than half of the maximal width, more preferably larger than 80% of the width.

Preferably, the maximal width is between 8 and 20 mm, more preferably between 10 and 20 mm.

Preferably, the multiple heatsink elements have different maximum heights, wherein the height is measured perpendicularly on the base. More in particular, the height may be adjusted to the heat generated at the location of the heatsink elements. In areas where more heat is generated, the height may be higher than in areas where less heat is generated. In a preferred embodiment, an average maximum height of a first set of heatsink elements in a central zone is higher than an average maximum height of a second set of heatsink elements in one or more peripheral zones at the edges of the central zone. The central zone will typically correspond with a zone right opposite the light source, when the assembly is a luminaire head.

Preferably, a maximum height (h) of at least some of the multiple heatsink elements is higher than 5 mm, preferably between 5 mm and 40 mm. Such heights allow for a good evacuation of heat whilst not being too high such that an inclination of a peripheral wall of a heatsink element does not have to be too steep.

In an exemplary embodiment, the housing is provided with a connection portion configured for connecting the assembly, e.g. a luminaire head, to a pole or other base, wherein the housing has a length direction extending away from the connection portion towards a free end of the housing. Preferably, the elongate shape of a heatsink element is oriented in the length direction. In that regard it is noted that the assembly, e.g. the luminaire head will often be slightly inclined in the length direction, i.e. the first side will generally not be oriented perfectly horizontally. By orienting the elongate shape of the heatsink elements in the length direction, liquid will be able to flow in the direction of inclination between the heatsink elements, resulting in an auto-cleaning of the assembly, e.g. the luminaire head.

In a typical embodiment where the electrical component is a light source, the light source comprises one or more carriers, such as printed circuit boards, on which a plurality of light emitting elements, typically light emitting diodes, is arranged. Thus the light source may extend along a surface area determined by the one or more printed circuit boards. Preferably, the one or more carriers are arranged to be in thermal contact with the first side. Preferably, the one or more carriers are fixed with screws to the first side of the housing. The screws may extend into the heatsink elements and/or optionally, the outer surface of the first side is provided with thickened portions in which the screws are fixed.

Preferably, seen in the length direction, the first side comprises a first substantially flat surface portion near the connection portion, a second substantially flat surface portion near the free end, said first surface portion being connected to said second surface portion through a sloped portion. The heatsink portion may then be formed by at least the second substantially flat surface portion and optionally also the sloped portion. In that manner the heatsink portion can extend easily over the entire surface area of the electrical component, e.g. the light source. In other embodiments, the heatsink elements could be located in the first portion only or in the first, the second and the sloped portion.

Preferably, seen in the length direction, the second side comprises a first substantially flat surface portion near the connection portion, a second substantially flat surface portion near the free end, and a sloped portion between said first surface portion and said second surface portion. The second portion may form the transparent or translucent portion when the assembly is a luminaire head. The second substantially flat surface portion of the second side may then be arranged opposite the second substantially flat surface portion of the first side, wherein the electrical component, e.g. the light source is included between those second surface portions. Optionally also, the second side may be provided with heatsink elements.

For example, the heat of the driver present in the housing could be evacuated via the heatsink elements, either on the upper or the lower side of the housing.

Preferably, the housing comprises a first housing part made of a thermally conductive material, preferably metal, said first housing part forming said first side and integrating the heatsink portion. The first housing part may then comprise, in one integral part, the first substantially flat surface portion, the second substantially flat surface portion near the free end, and the sloped portion in between.

Preferably, a thickness of the first housing part in areas of the surface adjacent the multiple heatsink elements is smaller than 15 mm, preferably between 2 mm and 10 mm.

Preferably, the housing comprises a second housing part cooperating with said first housing part for creating a compartment for housing a plurality of components, such as a driver. Preferably, the compartment is created near the connection portion, away from the free end of the assembly, e.g. the luminaire head.

Preferably, when the assembly is a luminaire head, the second housing part is arranged at the second side next to the transparent or translucent portion, more preferably between the connection portion and the transparent or translucent portion.

Preferably, the second housing part is pivotally arranged with respect to the first housing part.

In other embodiments a portion of housing part, e.g. a surface portion may be pivotally arranged with respect to the second housing part, and the second housing part may be a fixed housing part. In such an embodiment the compartment may be accessed from the upper side of the luminaire head.

Preferably, the multiple heatsink elements comprise at least sixteen heatsink elements, preferably at least twenty five heatsink elements. When the assembly is a luminaire head, preferably, the ratio between the number of heatsink elements and the number of light emitting elements of the light source is between 0.4 and 1.5, more preferably between 0.6 and 1.2. It has been found that such a ratio provides for an adequate cooling of the luminaire head for typical light sources used in outdoor luminaires.

Preferably, the heatsink elements are arranged according to a pattern with multiple heatsink elements positioned next to each other in a first direction and with multiple heatsink elements positioned next to each other in a second direction, wherein the first direction is different from the second direction. The first direction may be perpendicular in the second direction. For example, the pattern may comprise multiple rows and columns of heat sink elements. In another embodiment the heatsink elements may be arranged along radial lines.

Preferably the heatsink elements are arranged according to a substantially regular pattern, e.g. an array of multiple columns and/or rows. The rows may be aligned or staggered with respect to each other. Similarly, the columns may be aligned or staggered with respect to each other. Also, the number of heatsink elements in a row/column may vary. Further, any other patterns are also possible.

Preferably, a total length of the luminaire head is between 500 mm and 1000 mm and/or a total width of the luminaire head is between 200 mm and 500 mm and/or a total thickness of the luminaire head is between 70 mm and 250 mm.

Preferably, the multiple heatsink elements are solid non-hollow elements.

Preferred embodiments relate to a luminaire head of an outdoor luminaire. By outdoor luminaire, it is meant luminaires which are installed on roads, tunnels, industrial plants, campuses, stadiums, airports, harbours, rail stations, parks, cycle paths, pedestrian paths or in pedestrian zones, for example, and which can be used notably for the lighting of an outdoor area, such as roads and residential areas in the public domain, private parking areas, access roads to private building infrastructures, etc.

Preferably the light source further comprises one or more optical elements associated with the plurality of light emitting elements. Preferably, the one or more optical elements comprise a plurality of lens elements associated with the plurality of light emitting element. Optionally, the plurality of lens elements may be integrated in one or more optical lens plates arranged above the one or more carriers on which the light emitting elements are mounted. Indeed, lens elements may be typically encountered in outdoor luminaire heads, although other types of optical elements may be additionally or alternatively present in such luminaires heads, such as reflectors, backlights, prisms, collimators, diffusors, and the like. In the context of the invention, a lens element may include any transmissive optical element that focuses or disperses light by means of refraction. It may also include any one of the following: a reflective portion, a backlight portion, a prismatic portion, a collimator portion, a diffusor portion. For example, a lens element may have a lens portion with a concave or convex surface facing a light source, or more generally a lens portion with a flat or curved surface facing the light source, and optionally a collimator portion integrally formed with said lens portion, said collimator portion being configured for collimating light transmitted through said lens portion. Also, a lens element may be provided with a reflective portion or surface or with a diffusive portion or surface. In some embodiments the one or more optical elements, such as one or more lens elements integrated in a lens plate, can form the transparent or translucent portion.

Embodiments of the invention may be useful for any kind of electrical components which need to be included in a closed housing and which generate heat. For example, the electrical component may be a processing means, a communication means, a sensor or a portion thereof, etc. The housing may be configured for being attached to a pole or included in a pole.

For example, the housing may be a box like module configured to be attached to a pole, e.g. a luminaire pole. An example of an assembly configured to be attached to a pole is described in WO2019043045A1 in the name of the applicant, which is included herein by reference. The assembly is a base station module configured to house base station communication means, but a similar module may be used to accommodate other electrical components. In some examples described in WO2019043045A1 air flow holes are provided in the housing to improve cooling. In addition or alternatively, heatsink elements according to embodiments described above may be provided on an outer surface of the housing, e.g. on the upper surface. In such an embodiment, it may be advantageous to mount the electrical component against this surface or in the vicinity of this surface.

According to another example, the housing may be a bracket-like component configured to be attached to a pole. Such bracket-like component may be accommodating e.g. a sensor, a processing means, a communication means, etc.

In another example, the housing may be part of a pole module configured to be part of a modular pole, e.g. a modular lamp post. Such modular pole comprises a plurality of pole modules arranged one above the other along a central axis thereof. Exemplary pole modules are described in patent applications WO2019043045A1, WO2019092273A1, PCT/EP2020/082269, WO2019053259A1, and WO2019043046A1 in the name of the applicant which are included herein by reference. Such pole module may be provided with a bracket comprising a compartment for housing an electrical component, and an outer surface of such bracket may be provided with heatsink elements according to embodiments described above. In addition or alternatively a peripheral surface of the housing of the pole module may be provided with heatsink elements.

In further exemplary embodiment, a control module, in particular a pluggable control module, may be added to the assembly, e.g. on the first side or on the second side of the housing. Preferably, the pluggable control module is configured to be plugged in a socket receptacle, e.g. a socket receptacle provided to a housing accommodating the light source of the luminaire system. More preferably, the socket receptacle is one of a NEMA or Zhaga socket receptacle, and the pluggable control module is a module configured to be plugged in such socket receptacle.

According to an exemplary embodiment, the socket receptacle and control module may be implemented as described in PCT publication WO2017/133793 in the name of the applicant, which is included herein by reference. Optionally, the socket receptacle and control module may be configured and/or mounted as described in patent application PCT/EP2020/068854 or PCT/EP2020/060751 in the name of the applicant, which are included herein by reference.

The socket receptacle and the control module may be configured to be coupled through a twist-lock mechanism, e.g. as described in ANSI C136.10-2017 standard or ANSI C136.41-2013 standard or Zhaga Interface Specification Standard (Book 18, Edition 1.0, July 2018, see https://www.zhagastandard.org/data/downloadables/1/0/8/1/book_18.pdf or Book 20:

Smart interface between indoor luminaires and sensing/communication modules), which are included herein by reference.

The assembly may be a smart-city device and may e.g. be any one of the following: a luminaire, a bin, a sensor device, a street furniture, a charging station, a payment terminal, a parking terminal, a street sign, a traffic light, a telecommunication cabinet, a traffic surveillance terminal, a safety surveillance terminal, a water management terminal, a weather station, an energy metering terminal, an access lid in a pavement. Existing structures ubiquitously present in cities may be used for hosting networks, limiting in this way the aesthetic impact of installing such networks. Structures having already an access to the power grid are particularly interesting, while luminaires having just the right height to capture all kinds of valuable data from sensors are further particularly suited.

### BRIEF DESCRIPTION OF THE FIGURES

The accompanying drawings are used to illustrate presently preferred non-limiting exemplary embodiments of devices of the present invention. The above and other advantages of the features and objects of the invention will become more apparent and the invention will be better understood from the following detailed description when read in conjunction with the accompanying drawings, in which:

FIG. 1 is a schematic perspective view of an exemplary embodiment of a luminaire head looking at the first side;

FIG. 1A shows a schematic perspective view of a heatsink element of the luminaire head of FIG. 1;

FIG. 1B is a section through the base of the heatsink element of FIG. 1A;

FIG. 1C is a section along a surface halfway the base and the top of the heatsink element of FIG. 1A;

FIG. 1D is a section along the height of the heatsink element of FIG. 1A;

FIG. 2 is a schematic perspective view of the exemplary embodiment of the luminaire head of FIG. 1 looking at the second side;

FIG. 3 is a schematic side view of the luminaire head of FIG. 1;

FIG. 4 is a schematic perspective view similar to the view of FIG. 2 but with the cover and light source removed to show an inner surface of the first side, and with the second housing part in an open position;

FIG. 5 is a schematic perspective view of an embodiment of an assembly attached to a pole;

FIG. 6 is a schematic perspective view of an embodiment of a pole module of a modular lamp post; and

FIG. 7 is a schematic perspective view of an embodiment of a bracket-like assembly for accommodating an electrical component.

### DESCRIPTION OF EMBODIMENTS

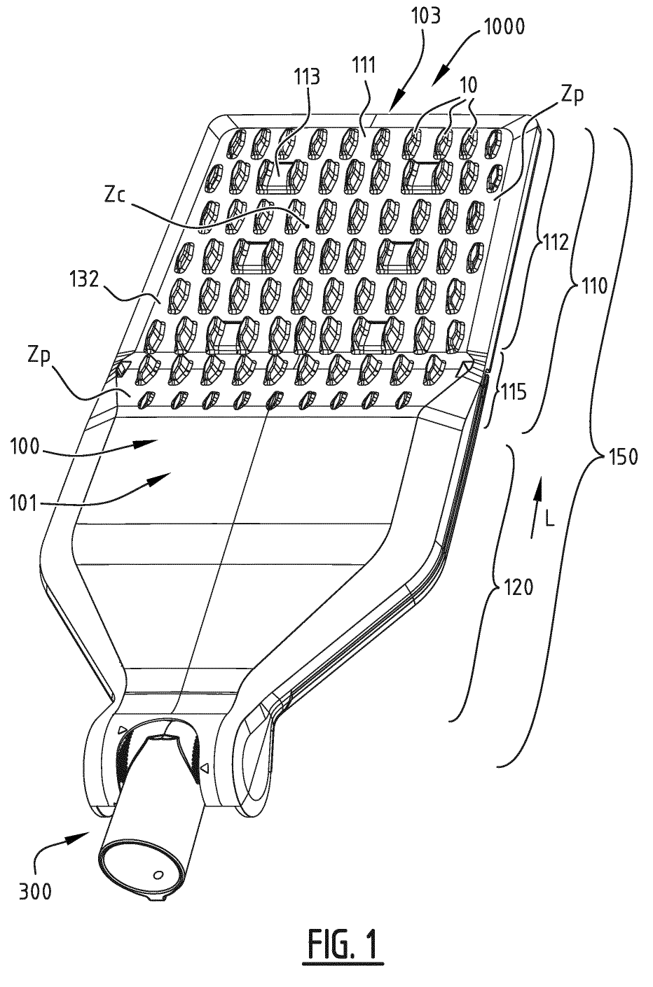

FIGS. 1-4 illustrate an exemplary embodiment of a luminaire head according to the invention.

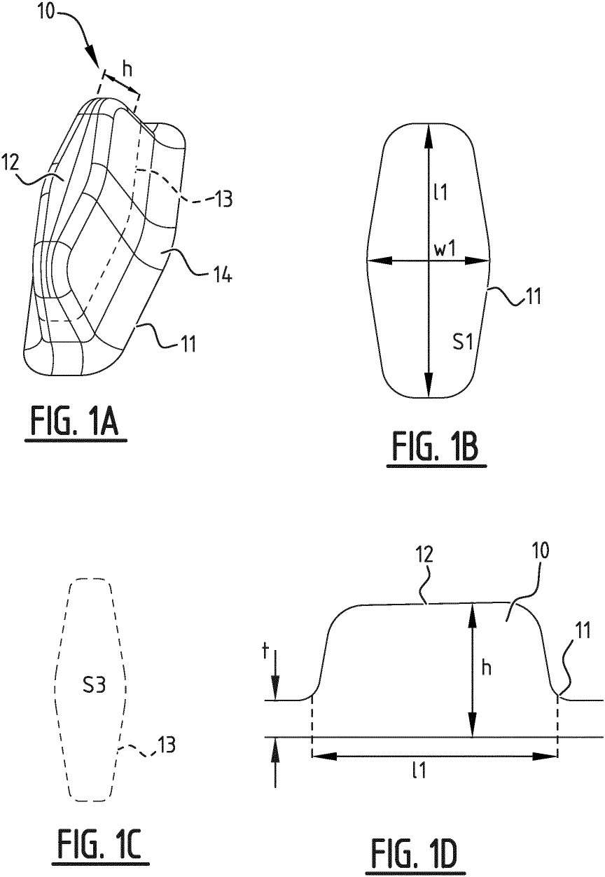

FIGS. 1 and 2 show that the luminaire head comprises a housing 100 and a light source 200 arranged in the housing 100. The housing 100 has a first side 101 (visible in FIG. 1) and a second side 102 (visible in FIG. 2) opposite the first side 101. The second side 102 is intended to be oriented towards the area to be illuminated, e.g. the ground. The first side 101 is typically an upper side of the luminaire head in the mounted position thereof. The second side 102 may be provided with a transparent or translucent portion 130 opposite the light source 200, such that light rays emitted by the light source 200 can leave the housing 100 through the transparent or translucent portion 130. The first side 101 is provided with a heatsink portion 110 opposite the light source 200. The heatsink portion 110 has a surface 111 provided with multiple heatsink elements 10 protruding outwardly out of said surface 111.

FIG. 1A shows in detail a heatsink element 10. The heatsink element 10 has a base 11 and a top 12. The heatsink element 10 gradually widens from the top 12 to the base 11. By providing multiple heatsink elements 10 which have a shape narrowing from the base 11 till the top 11, water and dirt can be more easily evacuated as the hill-like shape will create fluid flows around the multiple heatsink elements 10. Further, such a shape of the multiple heatsink elements 10 allows for a convenient demoulding of the heatsink portion 110 out of a mould, and allows the heatsink elements 10 to be an integral part of the housing 100. Indeed, the heatsink portion 130 is one integral moulded portion made of a heat conductive material and integrating the heatsink elements 10. Preferably, the multiple heatsink elements 10 are solid non-hollow elements.

As show in FIG. 1B, seen in a cross section, a base surface area S1 of the heatsink element 10 at the base 11 is at least 10% larger than a middle surface area S3 of the heatsink element 10 halfway (at reference numeral 13 in FIG. 1A) between the top 12 and the base 11. The peripheral wall 14 of the heatsink element 10 is curved between the base surface area S1 and the middle surface area S3, and runs gradually inwardly from the base 11 to an edge 13 of the middle surface area S3. This curvature will help the demoulding as the curved narrowing peripheral wall 14 does not have sharp angles and can easily be removed from the mould. At the same time a fluid flow can run smoothly over the peripheral wall 14. Further, by having a curved peripheral wall 14, the surface area of the peripheral wall is increased.

The heatsink element 10 has an elongate shape. Preferably, as indicated in FIG. 1B, at the level of the base 11, a maximal length 11 is at least 1.3 times, preferably at least 1.5 times a maximal width w1. By using an elongate shape, the surface area of the heatsink element 10 is further increased, resulting in an improved evacuation of heat. Preferably, for at least some of the multiple heatsink elements 10, the maximal length 11 is between 5 mm and 100 mm, more preferably between 5 mm and 60 mm, e.g. between 15 mm and 50 mm. Such lengths allow on the one hand a good evacuation of heat and on the other hand a good flow of fluid (e.g. water and/or dirt) in between the heatsink elements 10.

As shown in FIG. 1, the multiple heatsink elements 10 may have different maximum heights h (h is indicated in FIGS. 1A and 1D), wherein the height is measured perpendicularly on the base 11. More in particular, the height h may be adjusted to the amount of heat generated at the location of the respective heatsink element 10. In areas where more heat is generated, the height may be higher than in areas where less heat is generated. As shown in FIG. 1, an average maximum height of a first set of heatsink elements 10 in a central zone Zc is higher than an average maximum height of a second set of heatsink elements 10 in one or more peripheral zones Zp at the edges of the central zone Zc. The central zone Zc will typically correspond with a zone right opposite the light source 200, see also FIG. 2 which shows the location of light emitting elements 210 of the light source 200 to be opposite the highest heatsink elements 10. For example, in FIG. 1 the second set of heatsink elements 10 comprises thirty-nine peripheral heat sink elements 10 with a height which is lower than the height of the first set of central heatsink elements 10. The skilled person understands that the numbers are merely examples, and that generally in other embodiments the first set may comprise two or more elements, preferably at least four elements, and that the second set may comprise two or more elements, preferably at least four elements. Further, in FIG. 1 the second set of heatsink elements 10 is located at four peripheral sides around the first set of heatsink elements 10, but it may be located only at one peripheral side or at two peripheral sides or at three peripheral sides. Preferably, a maximum height h of at least some of the multiple heatsink elements 10 is between 5 mm and 40 mm. For example, all heights in the central zone Zc may have a height h between 5 mm and 40 mm. Such heights h allow for a good evacuation of heat whilst not being too high such that an inclination of the peripheral wall 14 of the heatsink element 10 does not have to be too steep.

Preferably the heatsink elements are arranged according to a substantially regular pattern for example as in FIG. 1 where the heatsink elements 10 are arranged according to an array with multiple staggered rows. As illustrated the number of heatsink elements 10 of a row may vary from one row to the next row.

The housing 100 is provided with a connection portion 300 configured for connecting the luminaire head to a pole or other base (not shown). The housing 100 has a length direction L extending away from the connection portion 300 towards a free end 103 of the housing 100. The elongate shape of a heatsink element 10 is oriented in the length direction L, i.e. the length direction L is parallel to the direction of the length 11. In that regard it is noted that the luminaire head will often be slightly inclined in the length direction L, i.e. the first side 101 will generally not be oriented perfectly horizontally. By orienting the length direction 11 of the heatsink elements 10 in the length direction L of the luminaire head, liquid will be able to flow in the direction of inclination L between the heatsink elements 10, resulting in an auto-cleaning of the luminaire head.

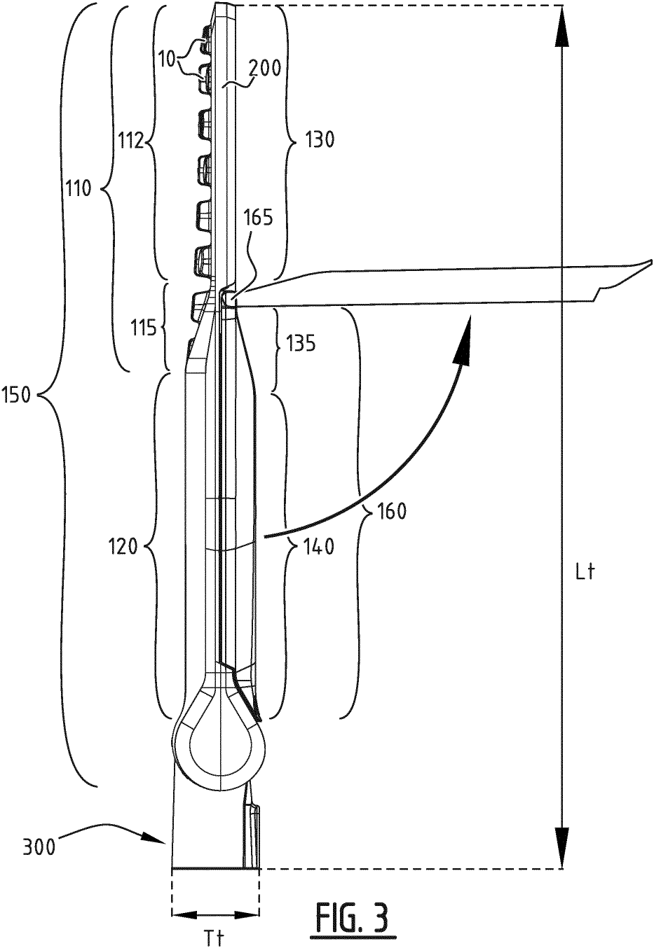

As shown in FIG. 2, the light source 200 comprises one or more carriers 230, such as one or more printed circuit boards, on which a plurality of light emitting elements 210, typically light emitting diodes, is arranged. Thus the light source 200 extends along a surface area determined by the one or more carriers 230. Preferably, the one or more carriers 230 are arranged to be in thermal contact with an inner surface 131 the first side 101, see also FIG. 4 which shows the luminaire head with the light source 200 removed revealing the inner surface 131 of the first side 101 against which the one or more carriers 230 are arranged.

The light source 200 further comprises one or more optical elements 220 associated with the plurality of light emitting elements 210. Preferably, the one or more optical elements 220 comprise a plurality of lens elements 220 associated with the plurality of light emitting element 210. Optionally, the plurality of lens elements 220 may be integrated in one or more optical lens plates (six lens plates each comprising twenty lens elements in the example of FIG. 2) arranged above the one or more carriers 230 on which the light emitting elements 210 are mounted.

Preferably, the one or more carriers 230 and optionally the one or more lens plates are fixed with screws into the inner surface 131 of the first side 101 of the housing 100. The screws 240 may be fixed into areas 116 of the inner surface 131 where heat sink elements 10 are present at the outer surface 132. Optionally, where a location 113′ of a screw 240 does not match with a heatsink element 10, the outer surface 132 of the first side 101 may be provided with thickened portions 113 in which screws 240 are fixed, see FIG. 2 showing some screws 240 at locations corresponding with the thickened portions 113, and FIG. 1 showing the thickened portions 113. Further positioning elements 117 may be provided on the inner surface 131 in order to facilitate the locating the one or more carriers 230 in proper position. Also, one or more ejector pin positions 118 may be provided to avoid that any burrs lift up the one or more carriers 230.

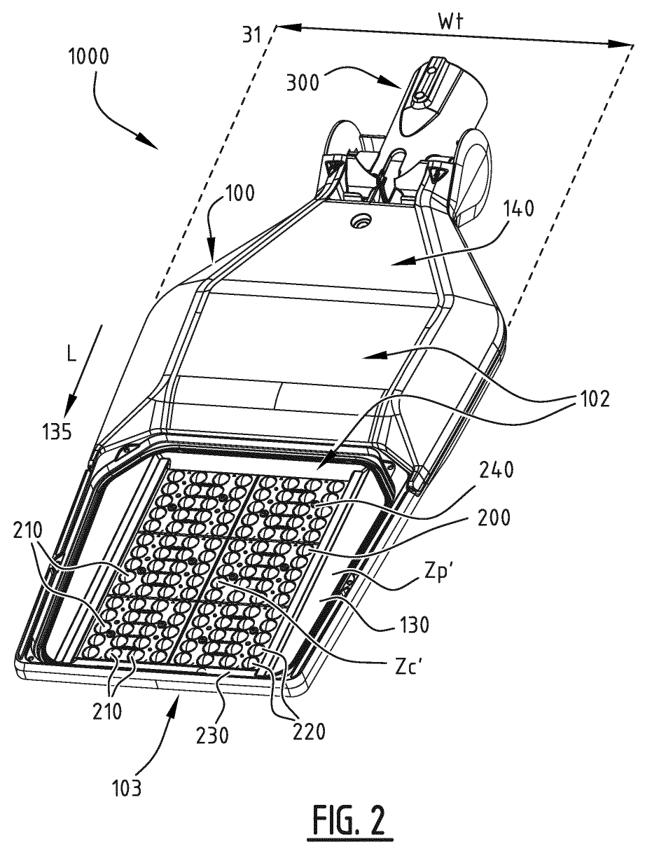

As is best visible in FIG. 1 and FIG. 3, seen in the length direction L, the first side 101 comprises a first substantially flat surface portion 120 near the connection portion 300, a second substantially flat surface portion 112 near the free end 103, and a sloped portion 115. The first surface portion 120 is connected to the second surface portion 112 through the sloped portion 115. The heatsink portion 110 is formed here by the second substantially flat surface 112 portion and the sloped portion 115. The sloped portion 115 may be provided on the inner side with ribs 119 strengthening the sloped portion 115 and providing support for the one or more carriers 230 on which the light emitting elements 210 are mounted. In that manner the heatsink portion 110 can extend easily over the entire surface area of the light source 200 ensuring a good heat dissipation.

As is best visible in FIG. 2 and FIG. 3, seen in the length direction L, the second side 102 comprises a first substantially flat surface portion 140 near the connection portion 300, a second substantially flat surface portion 130 near the free end 103. The first surface portion 140 is connected to a sloped portion 135 leading to the second surface portion 130. The second surface portion 130 forms the transparent or translucent portion. The second substantially flat surface portion 130 of the second side 102 may then be arranged opposite the second substantially flat surface portion 112 of the first side 101, wherein the light source 200 is included between those second surface portions 130, 112.

As illustrated in FIG. 3, the housing 100 comprises a first integral housing part 150 (including surface portions 112, 115, 120) made of a thermally conductive material, preferably metal, said first housing part 150 forming said first side 101 and integrating the heatsink portion 110. Preferably, a thickness of the first housing part 150 in areas of the surface adjacent the multiple heatsink elements 10 is smaller than 15 mm, preferably between 2 mm and 10 mm. The housing 100 comprises a second housing part 160 (including surface portions 135, 140) cooperating with said first housing part 150 for creating a compartment 170 (see also FIG. 4) for housing a plurality of components, such as a driver. The second housing part 160 may also be one integral metal part. Preferably, the compartment 170 is created near the connection portion 300, away from the free end 103 of the luminaire head. The second housing part 160 is arranged at the second side 102 next to the transparent or translucent portion 130, more preferably between the connection portion 300 and the transparent or translucent portion 130. The second housing part 160 may be pivotally arranged with respect to the first housing part 150, see FIG. 4 which shows a pivot axis at reference numeral 165. In other embodiments a portion of housing part 150, e.g. surface portion 120 may be pivotally arranged with respect to the second housing part 160, and the second housing part 160 may be a fixed housing part. In such an embodiment the compartment 170 may be accessed from the upper side of the luminaire head.

As shown in FIG. 1, the multiple heatsink elements 10 comprise at least sixteen heatsink elements 10, preferably at least twenty five heatsink elements 10. Preferably, the ratio between the number of heatsink elements 10 and the number of light emitting elements 210 of the light source 200 is between 0.4 and 1.5, more preferably between 0.6 and 1.2. It has been found that such a ratio provides for an adequate cooling of the luminaire head for typical light sources 200 used in outdoor luminaires.

Preferably, a total length Lt of the luminaire head is between 500 mm and 1000 mm and/or a total width Wt of the luminaire head is between 200 mm and 500 mm and/or a total thickness Tt of the luminaire head is between 70 mm and 250 mm.

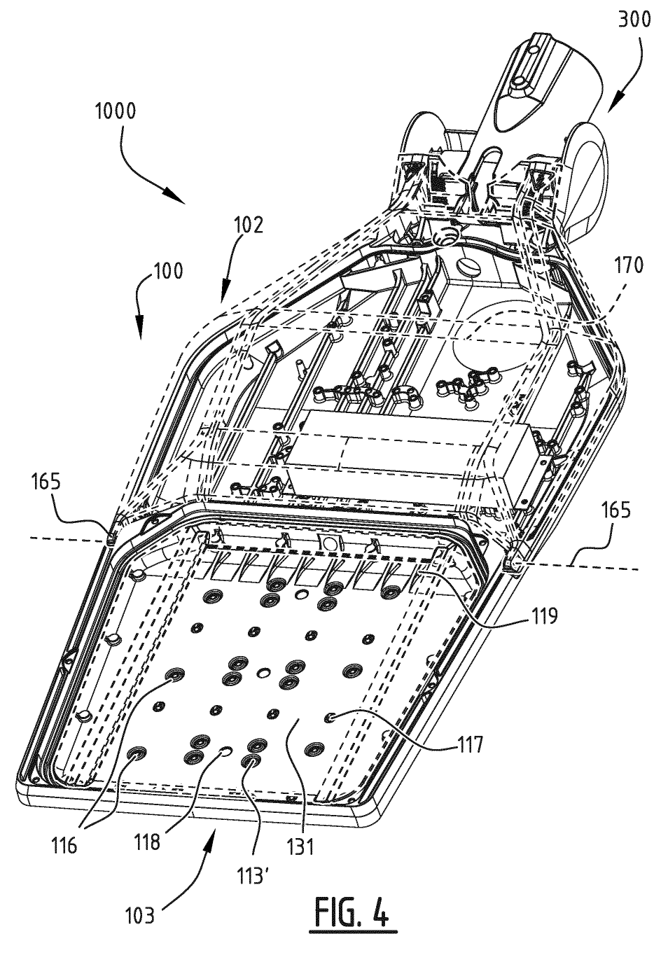

FIG. 5 shows an embodiment of an assembly comprising a housing 100 and an electrical component 200 arranged in the housing 100. The housing 100 has a first side 101, typically an upper side of the assembly in the mounted position thereof. The first side 101 is provided with a heatsink portion having an upper surface 111 provided with multiple heatsink elements 10 protruding outwardly out of said upper surface 111. The heatsink elements 10 may have any one of the properties of embodiments described above. Preferably, the upper surface 111 is an inclined surface extending downwardly away from the pole such that water and dirt can be easily evacuated. The housing 100 may be configured to be attached to a pole, e.g. as described in WO2019043045A1 in the name of the applicant, which is included herein by reference. The heatsink elements 10 may be oriented with their length direction in a length direction of the inclined surface.

Alternatively or in addition, heatsink elements could be present on lateral surfaces of the housing and/or on the lower side of the housing, depending on where the heat dissipating elements are located in the housing and/or depending on the quantity of heat that needs to be dissipated. Using a pattern of distinct heatsink elements presents the advantage to prevent dirt, trash to be stuck between the heatsink elements compared to standard heat fins.

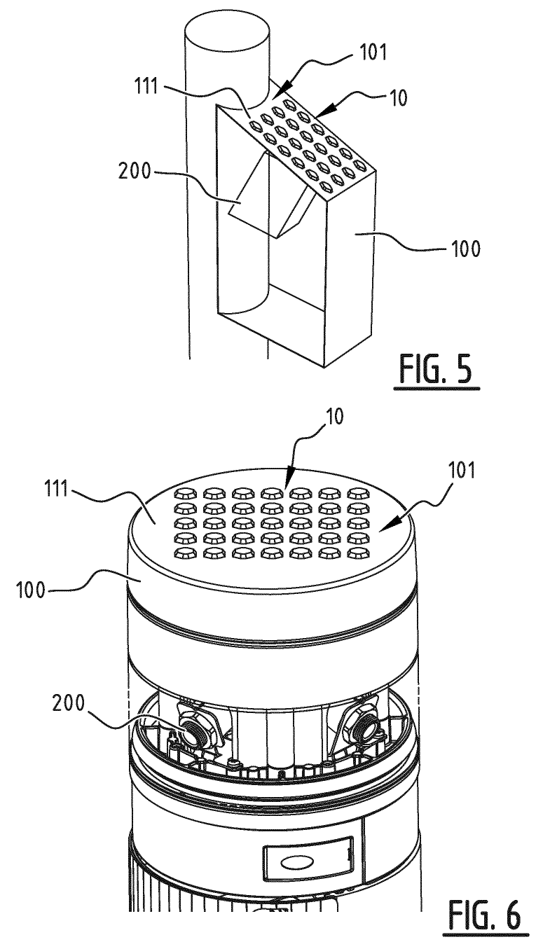

FIG. 6 shows an embodiment of an assembly in the form of a pole module, here a top pole module of a modular pole, e.g. a modular lamp post. The pole module comprises a housing 100 and an electrical component 200, e.g. a camera or other environmental sensor, arranged in the housing 100. The housing 100 has a first side 101, here an upper side of the pole module. The first side 101 is provided with a heatsink portion having an upper surface 111 provided with multiple heatsink elements 10 protruding outwardly out of said upper surface 111. The heatsink elements 10 may have any one of the properties of embodiments described above. Preferably, the upper surface 111 is a slightly curved surface extending radially downwardly away from the centre thereof such that water and dirt can be easily evacuated. The housing 100 may be configured to be attached to a lower pole module, e.g. as described in WO2019043045A1 or WO2019092273A1 or PCT/EP2020/082269, WO2019053259A1, and WO2019043046A1 in the name of the applicant, which are included herein by reference. The heatsink elements 10 may be oriented with their length direction in a radial direction of the upper surface 111.

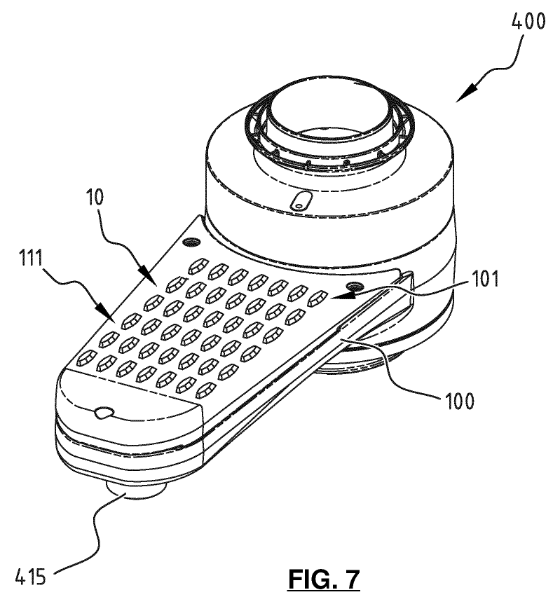

FIG. 7 shows an embodiment of an assembly in the form of a pole module of a modular pole, e.g. a modular lamp post. The pole module 400 comprises a housing 100 with a bracket-like section and one or more electrical components (not shown), e.g. a camera, a driver, a processor, another environmental sensor, arranged at least partially in the housing 100. Optionally a portion 415 of the electrical component may extend out of the housing. The housing 100 has a first side 101, here an upper side of the bracket-like section of the housing 100. The first side 101 is provided with a heatsink portion having an upper surface 111 provided with multiple heatsink elements 10 protruding outwardly out of said upper surface 111. The heatsink elements 10 may have any one of the properties of embodiments described above. Preferably, the upper surface 111 is a slightly inclined surface extending outwardly and/or downwardly away from a central axis of the pole module 400, such that water and dirt can be easily evacuated. The housing 100 may be configured to be attached to a lower pole module, e.g. as described in WO2019043045A1 or WO2019092273A1 or PCT/EP2020/082269, WO2019053259A1, and WO2019043046A1 in the name of the applicant, which are included herein by reference. The heatsink elements 10 may be oriented with their length direction in a length direction of the bracket-like section of the housing 100. In the illustrated embodiment the bracket-like section is part of a pole module. However, in other embodiments the assembly may only comprise a bracket-like section which is configured to be attached to a pole or other base.

In the examples of the figures, the heatsink elements 10 are shown to be arranged on an upper outer surface of the housing. Alternatively or in addition, the heatsink elements 10 may be arranged on a lower outer surface and/or on a peripheral outer surface of the housing. Preferably, the heatsink elements are arranged according to a pattern with multiple heatsink elements positioned next to each other in a first direction and with multiple heatsink elements positioned next to each other in a second direction, wherein the first direction is different from the second direction. The first direction may be perpendicular in the second direction. For example, the pattern may comprise multiple rows and columns of heat sink elements. In another embodiment the heatsink elements may be arranged along multiple radial lines.

Whilst the principles of the invention have been set out above in connection with specific embodiments, it is to be understood that this description is merely made by way of example and not as a limitation of the scope of protection which is determined by the appended claims.

1. An assembly, such as a luminaire head (1000), comprising a housing and an electrical component, such as a light source, arranged in the housing, said housing having a first side and an optional second side opposite the first side,
wherein at least the first side is provided with a heatsink portion having an outer surface provided with multiple heatsink elements protruding outwardly out of said outer surface, wherein a heatsink element thereof has a base and a top, and wherein the heatsink element gradually widens from the top to the base.

2. The assembly of claim 1, wherein the electrical component is a light source, and wherein the second side is provided with a transparent or translucent portion opposite the light source.

3. The assembly of claim 1, wherein seen in a mounted position, the first side is an upper side and the outer surface is an upper outer surface.

4. The assembly of claim 1, wherein, seen in a cross section, a base surface area of the heatsink element at the base is at least 10% larger than a middle surface area of the heatsink element halfway between the top and the base.

5. The assembly of claim 1, wherein, seen in a cross section parallel to the base, the heatsink element has an elongate shape, wherein preferably, at the level of the base, a maximal length is at least 1.3 times a maximal width, preferably at least 1.5 times the maximal width, and optionally wherein the maximal length is less than 7 times the maximal width, preferably less than 5 times, more preferably less than 4 times,
and/or wherein, for at least for some of the multiple heatsink elements, the maximal length is between 5 mm and 60 mm, preferably between 10 and 60 mm, more preferably between 15 mm and 50 mm.

6. (canceled)

7. (canceled)

8. The assembly according to claim 1, wherein a distance between two adjacent heatsink elements of said multiple heatsink elements is more than 8 mm, preferably more than 10 mm.

9. The assembly of claim 1, wherein the multiple heatsink elements have different maximum heights measured perpendicularly on the base, and/or
wherein an average maximum height of a first set of heatsink elements in a central zone is higher than an average maximum height of a second set of heatsink elements in one or more peripheral zones at one or more edges of the central zone, and/or
wherein a maximum height of at least some of the multiple heatsink elements is higher than 5 mm, preferably between 5 mm and 40 mm.

10. (canceled)

11. (canceled)

12. The assembly of claim 1, wherein the housing is provided with a connection portion configured for connecting the assembly to a pole or other base, and wherein the housing has a length direction extending away from the connection portion towards a free end of the housing.

13. (canceled)

14. The assembly of claim 2 , wherein the light source comprises a plurality of light emitting elements arranged on one or more carriers, such as one or more printed circuit boards, wherein preferably a ratio between the number of heatsink elements and the number of light emitting elements is between 0.4 and 1.5, wherein the one or more carriers are arranged to be in thermal contact with the first side, and wherein optionally, one or more carriers are fixed with screws against the heatsink portion, said screws preferably fixed in thickened portions provided to the outer surface of the first side.

15. (canceled)

16. (canceled)

17. The assembly of claim 12 , wherein, seen in the length direction, the first side comprises a first substantially flat surface portion near the connection portion, a second substantially flat surface portion near the free end, said first surface portion being connected to said second surface portion through a sloped portion, wherein the heatsink portion comprises at least said second substantially flat surface portion and optionally said sloped portion.

18. The assembly of claim 12, wherein the electrical component is a light source, wherein the second side is provided with a transparent or translucent portion opposite the light source, and wherein, seen in the length direction, the second side comprises a first substantially flat surface portion near the connection portion, a second substantially flat surface portion near the free end, and a sloped portion between said first surface portion and said second surface portion, said second portion forming the transparent or translucent portion.

19. The assembly of claim 1, wherein the housing comprises a first housing part made of a thermally conductive material, preferably a metal, said first housing part forming said first side and integrating the heatsink portion, and optionally, wherein a thickness of the first housing part in areas of the surface adjacent the multiple heatsink elements is smaller than 15 mm, preferably between 2 mm and 10 mm.

20. (canceled)

21. The assembly of claim 19, wherein the housing comprises a second housing part cooperating with said first housing part for creating a compartment for housing a plurality of components, such as a driver, and wherein, optionally, the second housing part is pivotally arranged with respect to the first housing part.

22. The assembly of claim 21, wherein the electrical component is a light source, wherein the second side is provided with a transparent or translucent portion opposite the light source, and wherein the second housing part is arranged at the second side next to the transparent or translucent portion.

23. (canceled)

24. The assembly of claim 1, wherein the multiple heatsink elements comprise at least sixteen heatsink elements, preferably at least twenty five heatsink elements.

25. (canceled)

26. The assembly of claim 1, wherein the assembly is a luminaire head, and wherein a total length of the luminaire head is between 500 mm and 1000 mm and/or wherein a total width of the luminaire head is between 200 mm and 500 mm and/or wherein a total thickness of the luminaire head is between 70 mm and 250 mm.

27. The assembly of claim 1, wherein the multiple heatsink elements are solid non-hollow elements.

28. An assembly, such as a luminaire head, comprising a housing and an electrical component, such as a light source, arranged in the housing, said housing having a first side and an optional second side opposite the first side,
wherein at least the first side is provided with a heatsink portion having an outer surface provided with multiple heatsink elements protruding outwardly out of said outer surface, wherein a heatsink element thereof has a base and a top and wherein the heatsink element gradually widens from the top to the base,
wherein, at the level of the base, a maximal length is at least 1.5 times the maximal width, and
wherein at the level of the base, a maximal length is between 5 mm and 60 mm.

29. An assembly, such as a luminaire head, comprising a housing and an electrical component, such as a light source, arranged in the housing, said housing having a first side and an optional second side opposite the first side,
wherein at least the first side is provided with a heatsink portion having an outer surface provided with multiple heatsink elements protruding outwardly out of said outer surface, wherein a heatsink element thereof has a base and a top, wherein the heatsink element gradually widens from the top to the base,
wherein seen in a cross section, a base surface area of the heatsink element at the base is at least 10% larger than a middle surface area of the heatsink element halfway between the top and the base, and
wherein the peripheral wall of the heatsink element, as seen in a longitudinal section extending in a length direction of the heatsink element and as seen in a transverse section extending in a width direction perpendicular on the length direction, is curved between the base surface area and the middle surface area, and runs gradually inwardly from the base to an edge of the middle surface area.
